(19) United States
(12) Patent Application Publication
(10) Pub. No.: US 2008/0311270 A1
(43) Pub. Date: Dec. 18, 2008

(54) Salad dressing

(76) Inventor: Gjon Gjokaj, Rochester Hills, MI (US)

Correspondence Address: HARNESS, DICKEY & PIERCE, P.L.C., P.O. BOX 828, BLOOMFIELD HILLS, MI, 48303, US

(21) Appl. No.: 11/903,802

(22) Filed: Sep. 10, 2007

Related U.S. Application Data
(60) Provisional application No. 60/843,489, filed on Sep. 8, 2006.

(51) Int. Cl. A23L 1/24

(52) U.S. Cl. 426/589

(57) ABSTRACT

A salad dressing and method for preparing such, having a unique flavor and improved taste, includes providing preselected quantities of mayonnaise as a base and adding additional ingredients in pre-selected quantities including, but not limited to, oregano, garlic, black pepper, sugar, beet juice or cranberry juice, water, vegetable oil, and red wine vinegar. In an alternative embodiment, a small amount of pepperoncini juice may be added to enhance the tanginess of the dressing. The food compound is prepared from a unique blend of natural and healthy ingredients.

### FIELD

The present disclosure relates to a food compound and method of preparing the same. In particular, the present invention is directed to making a salad dressing which is prepared from a unique blend of natural and healthy ingredients and has a unique flavor.

### BACKGROUND

The statements in this section merely provide background information related to the present disclosure and may not constitute prior art.

As the world keeps changing and moving at a faster pace each day, people's habits and tastes change in accordance therewith. In particular, as technology advances at a staggering rate, many companies learn more about the effects of various nutritional and non-nutritional food items consumed daily on our health. Salad dressings of various types, which are used to enhance the flavor of vegetables and salads, are widely commercially available as prepared foods. In addition, some types of salad dressings may be concocted with little preparation time. For example, a palatable Russian dressing may be made by mixing mayonnaise, catsup, salt, and pepper to taste.

Salad dressings are usually emulsified viscous fluid foods prepared from oil, an acidifying ingredient, an egg-yoke-containing material, and various flavoring agents, such as spices, salt, and sugar. The flavor of such dressings may be varied by changing the amounts of the ingredients, and the resulting preparations are often styled as French, Russian, Blue Cheese, or Thousand Island dressings. For example, French dressing usually contains about thirty-five to seventy percent vegetable oil, about 0.5 to 2.0 percent vinegar measured as acetic acid, about 0.15 to 0.75 percent emulsifying agent (usually a vegetable gum), and various flavoring agents.

The industry has produced countless numbers of food items that are low in fat, low in calories, and apparently healthier. For example, several recent studies have shown the benefits of red wine on the human body, as a natural anti-oxidant. It has been challenging to provide a food product which is healthy and yet satisfies consumers' constant urge for a new and better taste. This phenomenon is no more visible than in salad dressings. As the consumers switched their diets to more natural and healthy ingredients, such as vegetables and fruits, the food industry responded by providing numerous varieties of salad dressings. One merely needs to visit a local grocery store to see many different varieties of salad dressings that adorn the shelves. However, many of these dressings either require the use of a large quantity to be palatable or are not considered healthy in that they do contain egg yolks, etc.

Accordingly, there is a need in the industry for a salad dressing which is prepared from a unique blend of natural and healthy ingredients and which coats the salad with its unique flavor while not having to use an excessive amount as in most conventional dressings.

### SUMMARY

It is therefore an object of the present invention to provide a novel salad dressing having an unusual and desirable flavor.

Another object of the invention is to provide a method of preparing a novel salad dressing which is relatively simple and may be carried out in a relatively short preparation time.

Briefly, in accordance with the principles of the present invention, a method for preparing a salad dressing is provided in which mayonnaise is combined with various ingredients including sugar, oregano, granulated garlic, black pepper, beet juice or cranberry juice, water, vegetable oil, and red wine vinegar.

More specifically, the invention embodies a salad dressing which may be prepared and stored in a refrigerated environment for a period of time prior to consuming.

Further areas of applicability will become apparent from the description provided herein. It should be understood that the description and specific examples are intended for purposes of illustration only and are not intended to limit the scope of the present disclosure.

### DETAILED DESCRIPTION

The following description is merely exemplary in nature and is not intended to limit the present disclosure, application, or uses.

In a preferred embodiment, the invention may be used to prepare an edible and tasty liquid food which may be used as a salad dressing. The following is exemplary in nature and yields approximately five U.S. gallons of dressing. Provided the ratio of ingredients relative to one another remains consistent, smaller or larger amounts may be prepared accordingly.

The foregoing ingredients are preferably combined in the proportions which follow: Ingredient proportion of 3 U.S. gallons of mayonnaise (Hellman's Real Mayonnaise or equivalent), is combined with 4 U.S. ounces of oregano, 4 U.S. ounces of granulated garlic, and 4 U.S. ounces of black pepper. To this mixture, approximately 16 U.S. ounces of sugar are added, along with 28 U.S. ounces of beet juice, 64 U.S. ounces of water, 64 U.S. ounces of vegetable oil, and 64 U.S. ounces of red wine vinegar. The ingredients are thoroughly mixed together until a generally even consistency is achieved throughout.

In an alternative embodiment, cranberry juice may be substituted for part or all of the beet juice, yielding a distinctly unique flavor.

In yet a further embodiment, to improve the tanginess of the flavor of the salad dressing, a small amount of pepperoncini juice may be added to the above ingredients to taste.

Thereafter, the mixture is subjected to refrigeration, preferably at temperatures of about 45° F. to about 50° F., for a predetermined duration.

It will be understood that various changes in the details, ingredients, and compositions, which have been herein described and illustrated in order to explain the nature of this invention, may be made by those skilled in the art and are within the principle and scope of the invention.

What is claimed is:

1. A salad dressing comprising:
a) approximately 3 U.S. gallons of mayonnaise per 5 gallon batch of dressing;
b) approximately 4 U.S. ounces of granulated garlic per 5 gallon batch of dressing;
c) approximately 4 U.S. ounces of black pepper per 5 gallon batch of dressing;
d) approximately 16 U.S. ounces of sugar per 5 gallon batch of dressing;
e) approximately 28 U.S. ounces of beet juice per 5 gallon batch of dressing;
f) approximately 64 U.S. ounces of water per 5 gallon batch of dressing;
g) approximately 64 U.S. ounces of vegetable oil per 5 gallon batch of dressing; and
h) approximately 64 U.S. ounces of red wine vinegar per 5 gallon batch of dressing.
